(19) United States
(12) Patent Application Publication
(10) Pub. No.: US 2011/0082648 A1
(43) Pub. Date: Apr. 7, 2011

(54) Microchip blood analyzer

(75) Inventor: Shigeki Matsumoto, Hyogo (JP)

(73) Assignee: USHIO DENKI KABUSHIKI KAISHA, TOKYO (JP)

(21) Appl. No.: 12/923,474

(22) Filed: Sep. 23, 2010

(30) Foreign Application Priority Data
Oct. 1, 2009 (JP) 2009-229489

(51) Int. Cl. G06F 19/00

(52) U.S. Cl. 702/19

(57) ABSTRACT

A microchip blood analyzer contains a mixing unit that mixes a sample and a test reagent with each other; a detection unit that detects a reaction of the mixture, a measurement unit that measures an amount of a specific ingredient in the sample; and a judgment unit that obtains a value using an approximate expression in a least-square method by using measurement data, compares a value obtained from an approximate expression and a value of the measurement data to obtain a deviation degree, and generates an output of a measurement result when the deviation degree is a prescribed value or greater.

### CROSS-REFERENCES TO RELATED APPLICATION

This application claims priority from Japanese Patent Application Serial No. 2009-229489 filed Oct. 1, 2009,the contents of which are incorporated herein by reference in their entirety.

### TECHNICAL FIELD

The present invention relates to a microchip blood analyzer, and specifically relates to a microchip blood analyzer characterized by data processing in the case where an error of measurement data occurs.

### BACKGROUND

Development and practical application of a biochemical analysis apparatus using a microchip has recently progressed, such as technologies, in which a reaction of a very small quantity of blood and a test reagent taken in a microchip is detected by using light, for example, a biochemical analysis apparatus disclosed in Japanese Patent Application Publication No. 2007-322208, is known as such technology.

In an automatic analyzer, such as a biochemical analysis apparatus, various considerations have been made about data processing, such as fixing a reaction process, improving data reliability, and warnings for detects in analysis results, for example, an automatic analyzer and an automated analysis method disclosed in Japanese Patent Application Publication No. 2006-33125. In such an apparatus and the method, a data processing is performed as set forth below.

First, an approximate expression is obtained from two or more points that have been selected from collection of measurement data obtained from the reaction. Next, in a similar manner, an approximate expression(s) is obtained by changing selected combinations of the measurement data. One of two or more approximate expressions obtained in such a manner, in which a deviation from the measurement data is smaller than a prescribed value, is adopted as an approximate expression for data processing. Next, it is checked whether a difference (deviation) between the adopted approximate expression and the measurement data used for operation is larger than a prescribed value, and a processing of issuing an alert is performed.

In FIG. 5 of Reference 2, a flow chart of the above-described procedure is shown. In the flow chart, first, assuming that a reaction formula is Abs=Ae^{-kt}+B, an unknown value B is temporarily determined from data around the end of the reaction. Next, the measurement data is classified into three parts, and data (t, Abs) of each part is substituted therein. Next, a candidate of each of the unknown values A and k is calculated from these equations. And it is judged whether a value, which is obtained by squaring the deviation between an approximate expression in each candidate obtained and the measurement data and distribution, is equal to or lower than a prescribed value, thereby making it an approximate expression candidate. These steps are performed in every combination of all the data so that the best result is determined as the approximate expression.

### SUMMARY

The present invention relates to a microchip blood analyzer comprising a mixing unit that mixes a sample and a test reagent; a detection unit that detects a reaction of the mixture mixed by the mixing unit; a measurement unit that measures an amount of a specific ingredient in the sample from the change of at least one of a current, a voltage, an absorbance, and a fluorescence intensity obtained by the detection unit; and a judgment unit that obtains an approximate expression in a least-square method by using the measurement data obtained by the detection unit, compares a value obtained from the approximate expression and a value of the measurement data to obtain a deviation degree, and generates an error output or a requiring special attention output when the deviation degree is a prescribed value or greater.

### BRIEF DESCRIPTION OF THE DRAWINGS

Other features and advantages of the present microchip blood analyzer will be apparent from the ensuing description, taken in conjunction with the accompanying drawings, in which:

FIG. 1 shows a diagram of an example of a microchip blood analyzer according to an embodiment of the present invention;

FIG. 2 is a diagram showing a microchip blood analyzer according to an embodiment;

FIG. 3A is a diagram of an example of normal measurement data showing absorbance change after mixing is completed, and a corresponding approximate expression, in the case where CRP (C reactivity protein) measurement is performed;

FIG. 3B is a diagram of an example of abnormal measurement data showing absorbance change after mixing is completed and a corresponding approximate expression, in the case where CRP (C reactivity protein) measurement is performed; and

FIG. 4 is a flow chart showing a processing procedure in a microchip blood analyzer according to an embodiment.

### DESCRIPTION

However, in the data processing method disclosed in Japanese Patent Application Publication No. 2006-33125, not only takes time to perform data processing but also requires acquiring a series of data over a long time from the early stage of the reaction to the end of the reaction. For example, there is a problem that a value of B, which is disclosed in paragraph 0016 of Japanese Patent Application Publication No. 2006-33125, can be analogized only after the reaction ends. Further, there is a problem that a result approximated by using the value (B), which is analogized as an initial value, is not always obtained as an optimum solution. On the other hand, in “a clinical examination apparatus at a medical spot” (Point of Care: POCT apparatus) using a microchip, prompt measurement at a bed side is demanded. Thus, it is necessary to calculate an operation processing result from the measurement data before a reaction ends completely. Furthermore, an effect of surface tension becomes large in a reaction, which is performed in a microchip, and as a result, an area of reaction with injected blood becomes small, whereby it is difficult to mix a test reagent and a sample such as blood and that a period from start of the reaction to start of measurement becomes long.

In view of the above-described problems, it is an object of the present invention to offer a microchip blood analyzer using a microchip, which is capable of detecting an abnormal reaction and calculating a measurement result for a short time without producing a bad measurement result to a user. To solve the problems, a microchip blood analyzer according to the present invention comprises a mixing unit that mixes a sample and a test reagent; a detection unit that detects a reaction of the mixture; a measurement unit that measures an amount of a specific ingredient in the sample from the change of at least one of a current, a voltage, an absorbance, and a fluorescence intensity obtained by the detection unit; a judgment unit that obtains an approximate expression in a least-square method by using the measurement data obtained by the detection unit, compares a value obtained from the approximate expression and a value of the measurement data to obtain a deviation degree, and when the deviation degree is a prescribed value or greater generates being an error output or a requiring special attention output. In the microchip blood analyzer, the approximate expression may be obtained after a mixing period during which the sample and the test reagent are mixed with each other and during part of an entire reaction period. In the microchip blood analyzer, the deviation degree may be a residual sum of squares of the value obtained from the approximate expression and a value of the measurement data. In the microchip blood analyzer, the approximate expression may be a polynomial. In the microchip blood analyzer, the mixing and the reaction may be performed in a microchip.

According to the microchip blood analyzer of the present invention, the operation processing of the measurement data is performed based on approximate calculation by using the least-square method, so that an optimal solution can be obtained as a measurement result, whereby a measurement error can be certainly recognized in the case of abnormal measurement. Furthermore, since the measurement data processing is performed by the least-square method, a measurement error can be accurately recognized by short-time measurement, so that the entire measurement can be processed more quickly.

Below is a brief overview of a microchip blood analyzer according to the present invention. The microchip blood analyzer according to the present invention is an apparatus that measures an amount of a specific material in a sample from the change through absorbance that can be obtained from a mixture of the sample and a test reagent. To prevent outputting an error measurement result due to problems attributed to a measurement unit, such as a problem of a sample, for example, blood coagulation, a poor storage of a test reagent or a chip, or abnormalities of the measurement apparatus, the apparatus approximates the obtained reaction process by an approximate expression and outputs a measurement error, as an abnormal reaction, when the sum (residual sum of squares) of the difference between an approximation result and corresponding measurement data is a prescribed value or greater.

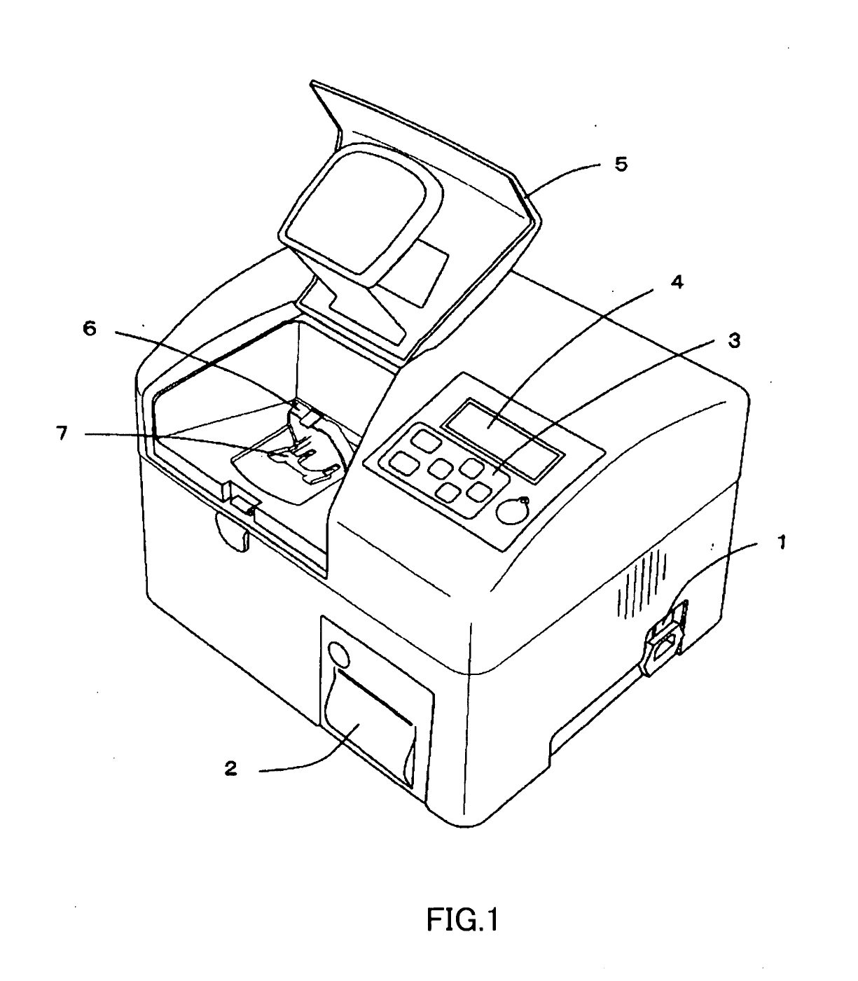

Next, description of an embodiment of the present invention will be given below referring to FIGS. 1-4. FIG. 1 is a diagram of an example of the microchip blood analyzer according to the present embodiment. As shown in the diagram, the microchip blood analyzer comprises an apparatus cover 5, a chip cover 6 provided under the apparatus cover 5, and a chip holder 7 provided under the chip cover 6, wherein the microchip (not shown) containing a sample is set in the chip holder 7. An operation unit 3 and a display unit 4 are provided beside the apparatus cover 5. Moreover, a printer unit 2, which prints out a measurement result, is arranged within the analyzer. As to power activation of the apparatus, the entire apparatus can be started up by turning on a power supply switch 1 provided on a side face thereof.

An operating procedure of the microchip blood analyzer is described below. First, the apparatus cover 5 and the chip cover 6 of the apparatus are opened, and the microchip, in which the sample is placed, is set in the chip holder 7. Next, when a start button of the display unit 3 is pushed, the sample (a very small quantity of blood) injected in the microchip is mixed with the test reagent, using a centrifugal force. The reaction of the sample (a very small quantity blood) and the test reagent is started by the mixing, and so is the measurement of the reactant. The measurement result is outputted to the printer 2 and the display part 4 after the measurement is completed.

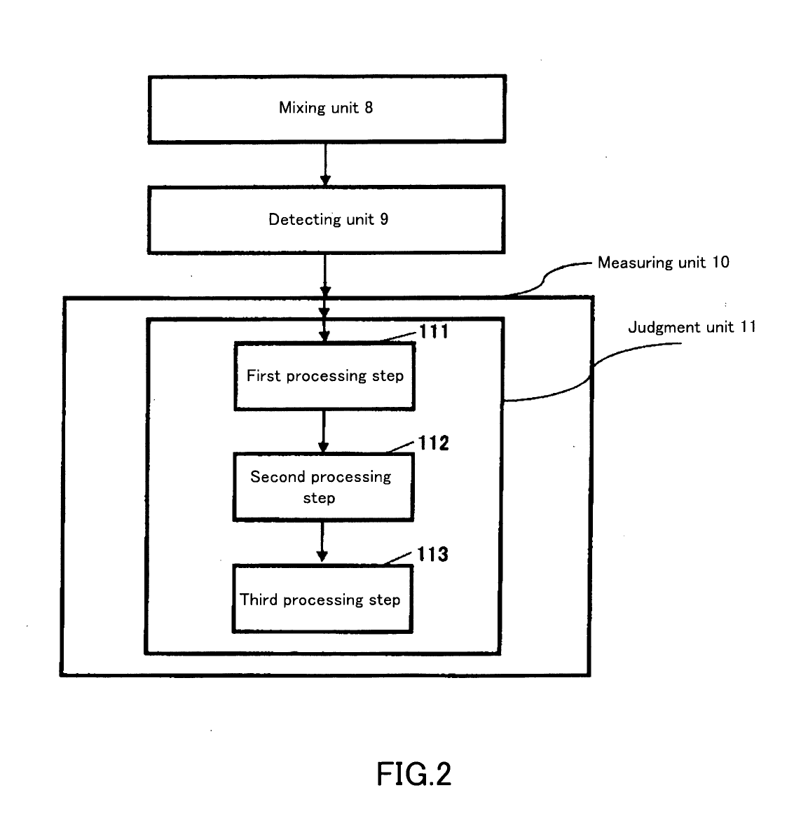

FIG. 2 is a diagram of a microchip blood analyzer according to an embodiment. As shown in this diagram, the microchip blood analyzer comprises a mixing unit 8 that mixes the sample and the test reagent; a detection unit 9 that detects the reaction of the mixture; and a measurement unit 10 that measures an amount of a specific ingredient in the sample from the change of at least one of a current, a voltage, an absorbance, and a fluorescence intensity obtained by the detection unit 9. Furthermore, the measurement unit 10 performs a first processing step 111 for obtaining an approximate expression by a least-square method, using the measurement data that is obtained by the detection unit 9, a second processing process 112 for comparing a value calculated from the approximate expression and a value of the measurement data to obtain a deviation degree, and a third processing step 113 for generating an error output or a requiring special attention output when the deviation degree is a prescribed value or greater.

Next, described is a processing procedure of the microchip blood analyzer according to the embodiment. For example, in the case of measurement of a CRP (C reactivity protein), a mixing period, during which, after a sample (blood) is put in a test reagent, the sample (blood) and the test reagent are mixed, is approximately one minute. The reaction of the mixture of the sample (blood) and the test reagent is started after the mixing period, and the reaction is detected by the detection unit 9. In the first processing step 111 of the judgment unit 11, an approximate expression, which may be a polynomial, for example, a second degree expression, is calculated by a least-square method based on the measurement data collected by the measurement unit 10 approximately one minute after the reaction starts. Next, in the second processing process 112 of the judgment unit 11, a value obtained from the approximate expression and a value of the measurement data are compared to calculate a deviation degree, for example, a residual sum of squares of the value obtained from the approximate expression and the value of measurement data. Next, in the third processing step 113 of the judging means 11, when the deviation degree (residual sum of squares) is the prescribed value or greater, an error or a requiring special attention output is generated. In addition, although it usually takes ten minutes or longer to thoroughly complete the reaction, the above-described measurement is performed to obtain the measurement result for as short a time as possible. Moreover, to measure a rate of change due to a reaction, it is desirable to collect data in an early stage of the reaction. Also, it takes approximately one minute to uniformly mix.

In addition, the residual sum of squares E can be expressed as follows:

E=Σ(y−ax²−bx−c)²

where a pair of actually measured measurement data is (x, y) and the approximate expression is “y=ax2+bx+c”. The constants a, b, and c can be obtained by solving a normal equation obtained by carrying out partial differentiation of both sides, using a least-square method, which determines the constants a, b, and c, by which the residual sum of squares E becomes the minimum.

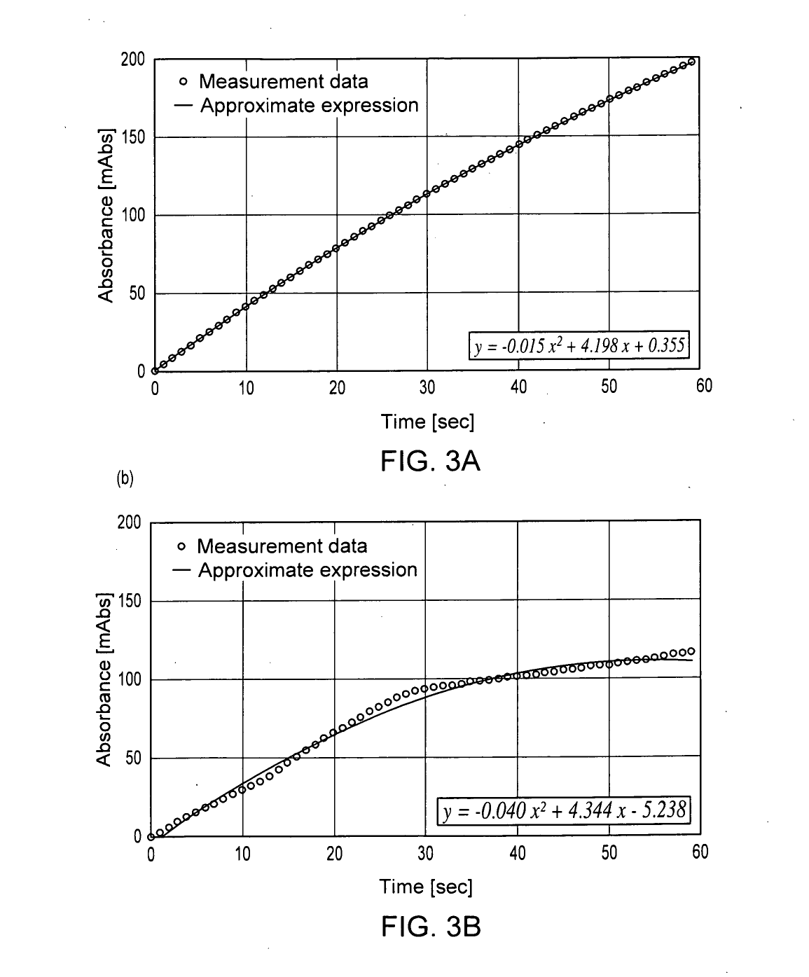

FIG. 3A is a diagram of an example of normal measurement data showing absorbance change after mixing is completed and an approximate expression corresponding thereto, in the case where CRP (C reactivity protein) measurement is performed. FIG. 3B is a diagram of an example of abnormal measurement data showing absorbance change after mixing is completed and an approximate expression corresponding thereto, in the case where the CRP (C reactivity protein) measurement is performed. Here, the measurement data is approximated by second degree equation using a least squares method, thereby obtaining the residual sum of squares between the measurement data and it. In FIG. 3A, the residual sum of squares is 2.74. On the other hand, the abnormal measurement data in FIG. 3B is data at time of measuring coagulated blood as an example of an abnormal sample, wherein the residual sum of squares is 666.9. Since there is a great difference in the residual sum of squares between the normal and abnormal data, a suitable value is set as a threshold (prescribed value) and the residual sum of squares and the threshold (prescribed value) are compared, whereby a judgment of an error in the measurement data is made. In the case where an error exists, the measurement result is not outputted. Specifically, when the CRP (C reactivity protein) is measured, for example, when the residual sum of squares is 10 or greater (10 is the threshold value (prescribed value)), it is determined as normal, and when it is the threshold (rated value) 10 or less, it is determined as abnormal. In addition, when the normal measurement data is acquired, in case of measurement of CRP (C reactivity protein) concentration, absorbance variation is calculated from absorbance at two points of the measurement data, which is determined in advance. The two points, for example, the tenth point and the fifty ninth point from start of the measurement are extracted, so that the absorbance variation is calculated. Next, the calculated absorbance variation is converted into the CRP concentration based on calibration information, which is memorized as computed absorbance variation (database, in which relation between the variation and the CRP concentration obtained by measuring in advance the absorbance variation corresponding to known CRP concentration, is collected). In such a manner, the obtained measurement result is printed out by the printer while it is outputted to the display unit.

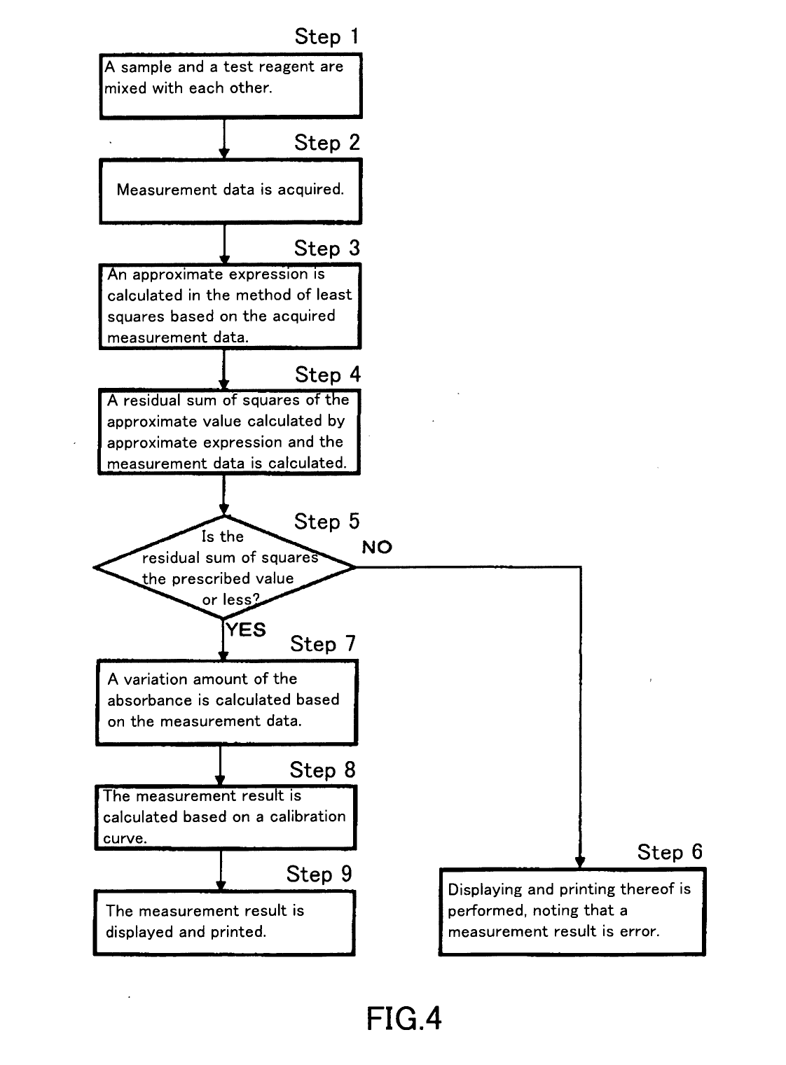

FIG. 4 is a flow chart showing a processing procedure of calculation of a concentration of material to be measured, such as CRP concentration in a microchip blood analyzer according to the embodiment. A sample and a test reagent are mixed in Step S1. In Step S2, measurement data is acquired while a reaction of the mixture of the sample and the test reagent starts, after mixing of the sample and the test reagent, and for a predetermined mixing period. In Step S3, an approximate expression is calculated in the method of least squares based on the acquired measurement data. In Step S4, a residual sum of squares of the approximate value calculated by the approximate expression and the measurement data is calculated. In Step S5, it is judged whether the residual sum of squares is the prescribed value or smaller, and when it is not the prescribed value or smaller, in Step S6, displaying and printing is performed, noting that a measurement result is an error. In Step S5, when it is judged that the residual sum of squares is the prescribed value or smaller, in Step S7, a variation amount of the absorbance is calculated based on the measurement data. Furthermore, in Step S8, the measurement result is calculated based on a calibration curve. Finally, in Step S9, the measurement result is displayed and printed.

The preceding description has been presented only to illustrate and describe exemplary embodiments of the present microchip blood analyzer. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope.

What is claimed is:

1. A microchip blood analyzer comprising:
a mixing unit that mixes a sample and a test reagent;
a detection unit that detects a reaction of the mixture mixed by the mixing unit;
a measurement unit that measures an amount of a specific ingredient in the sample from the change of at least one of a current, a voltage, an absorbance, and a fluorescence intensity obtained by the detection unit; and
a judgment unit that obtains an approximate expression in a least-square method by using the measurement data obtained by the detection unit, compares a value obtained from the approximate expression and a value of the measurement data to obtain a deviation degree, and generates an error output or a requiring special attention output when the deviation degree is a prescribed value or greater.

2. The microchip blood analyzer according to claim 1, wherein after a mixing period during which the sample and the test reagent are and during part of an entire period from start to end of the reaction the judgment obtains the approximate expression in a least-square method by using the measurement data obtained by the detection unit.

3. The microchip blood analyzer according to claim 1 or 2, wherein the deviation degree is a residual sum of squares of the value obtained from the approximate expression and the value of the measurement data.

4. The microchip blood analyzer according to claim 1, wherein the approximate expression is a polynomial.

5. The microchip blood analyzer according to claim 1, wherein mixing of the sample and the test reagent and the reaction of the mixture are performed in a microchip.
